(19) United States
(12) Patent Application Publication
(10) Pub. No.: US 2026/0056169 A1
(43) Pub. Date: Feb. 26, 2026

(54) Expanded Bed Chromatography Apparatus

(71) Applicant: Biotechflow Ltd, Gloucestershire (GB)

(72) Inventor: Martin Hofmann, Gloucestershire (GB)

(21) Appl. No.: 18/847,071

(22) PCT Filed: Mar. 16, 2023
(86) PCT No.: PCT/EP2023/056791

§ 371 Date: Sep. 13, 2024

(30) Foreign Application Priority Data
Mar. 16, 2022 (GB) 2203613.1

(51) Int. Cl. G01N 30/60

(52) U.S. Cl. CPC G01N 30/606; G01N 30/6017

(57) ABSTRACT

The field of chromatography, specifically the field of expanded bed chromatography. The invention is an expanded bed chromatography apparatus 1 which has an elongate tube 4 defining an operating volume 8 and having a central axis 7. The top end of the tube is sealed with a cap 2 having an exit port 3. The other end of the tube 4 is connected to a base 5. The base includes a process fluid inlet having a plurality of outlet apertures 10a, 10b, 10c in fluid communication with the operating volume of the tube and an inlet aperture 11 in fluid communication with the plurality of outlet apertures. Each of the plurality of outlet apertures is spaced radially from the central axis of the tube. In use, a mobile phase of process fluid passes up through a particulate media in the tube from the inlet to the exit port in a cap at the top of the apparatus. Target product is adsorbed onto the particulate media and is subsequently eluted from it. Alternatively, impurities are adsorbed on the particulate media and the target solution passes through the expanded bed for collection.

### CROSS-REFERENCE TO RELATED APPLICATIONS

This application is the United States national phase of International Application No. PCT/EP2023/056791 filed Mar. 16, 2023, and claims priority to United Kingdom Patent Application No. 2203613.1 filed Mar. 16, 2022, the disclosures of which are hereby incorporated by reference in their entireties.

### BACKGROUND OF THE INVENTION

### Field of the Invention

The present disclosure relates to expanded bed chromatography apparatus.

### Description of Related Art

Chromatography has traditionally used packed beds of particulate media (which includes the stationary phase e.g. coated on an inert porous core material such as agarose), retained within a tube between end retaining structures which keep the bed of media in place while allowing passage of liquid components (also known as the mobile phase) through the closely packed particulate media. The end retaining structures (such as a tube base and a top cap) are connected to the tube and have a mesh through which liquid but not media particles can pass.

In recent years the industrial-scale production of biologically-produced molecules, e.g. for drugs, vaccines or diagnostic agents, has become of great technical and economic importance. Many such target products are produced in cell cultures, typically a recombinant cell line such as Chinese Hamster Ovary monoculture, yeast, bacterial (e.g. E. coli), plant (e.g. tobacco) or milk. The target products (or their precursors) must be separated from a culture product (e.g. a biomass/broth feedstock or slurry) and nutrients which typically contains insoluble solids such as cell debris, DNA, RNA, host cell proteins and phospholipids as well as contaminants such as side products and buffer components used in the mobile phase. The culture product cannot be passed as a mobile phase through a packed bed to adsorb the product chromatographically (preparative chromatography) because the solids would block the system. Rather, the culture product must first be processed to remove the solid matter and derive a process fluid able to pass through a packed chromatography bed.

Expanded bed adsorption enables separation of target components from such culture products without preliminary centrifugation or filtration. In expanded bed adsorption, an unclarified process fluid (mobile phase) containing all the components of the cell cultures flows upwards through a bed of adsorbent media particles in expanded (fluidised) state. As described above, the expanded media is retained within a tube/column connected to end retaining structures such as a base at the bottom of the tube and a fixed cap or adjustable piston at the top. Solid material in the process fluid passes entirely through the bed to an exit port in the top end retaining structure. The inlet to the tube and exit port are without meshes. Target product is adsorbed onto the particulate media and is subsequently eluted (washed) from it. Alternatively, the impurities are adsorbed on the particulate media and the target solution passes through the expanded bed for collection (known as flow-through mode).

The means of injecting of the unclarified process fluid (mobile phase) into an expanded bed adsorption chromatography apparatus is important in achieving effective separation of the target product. Some existing expanded bed adsorption chromatography apparatus include a disc having radially extending spokes located just above the bottom of the tube. The process fluid is injected downwards towards the base of the tube from injection ports spaced along the radially extending spokes. The process fluid then flows upwards towards the top of the tube and the target product is separated from the process fluid as described above. The disc is a rotating disc which rotates as the process fluid is injected in order to promote stable plug flow (i.e. flow having a uniform flow profile across the cross-section of the tube). As the injected process fluid moves up the column, visible bands appear where the target product has bound to the adsorbent media particles. The inlet conduit into the tube for the process fluid (i.e. the inlet conduit which is in fluid communication with the injection ports) is a vertical pipe which extends from the underside of the apparatus through a metal base and into the rotating disc.

In alternative expanded bed chromatography columns, the inlet for process fluid may be at the axial centre of the base.

Expanded bed adsorption chromatography presents major technical challenges. It is difficult to maintain the expanded bed in a stable and effective state. It is important that the process fluid travels up through the expanded bed of adsorbent media particles in a tight band (i.e. narrow in the vertical (flow) direction and level across the cross-section of the tube in the horizontal direction which is perpendicular to the flow direction). If a tight, uniform band cannot be achieved, contamination or reduced concentration of the target product may occur following elution, which can pose significant risks to the quality of the output from the apparatus (e.g. purity and percentage recovery of the target product). This is particularly undesirable when the target product output from the chromatography apparatus is used for injectables, drugs, vaccines or diagnostic agents. Similarly, the process of cleaning in place which occurs after the target product has been eluted may be less efficient if a tight, uniform band of the remaining process fluid is not achieved.

External contamination can also be a problem. When the target product output from the chromatography apparatus is used for drugs, vaccines or diagnostic agents, it is important that the equipment remains sterile/hygienic/sanitary. Moreover, if used for multiple consecutive processes, it is important that the equipment is sterile/hygienic/sanitary and decontaminated between each use. This process often requires cleaning solution (e.g. alkaline solution) in much larger volumes than the volume of the tube.

Further, the bed of adsorbent media particles can be particularly expensive. It is important to ensure that these particles are used efficiently within the apparatus.

Existing expanded bed adsorption chromatography apparatus are complex and costly to manufacture. In addition, there are many sites liable to contamination. For example, in the existing apparatus described above an aperture for a motor driven shaft to be coupled to the rotating disc is required. This may be a source of contamination.

The present disclosure has been devised in light of the above considerations.

### SUMMARY OF THE INVENTION

In a first aspect there is provided an expanded bed chromatography apparatus comprising: a tube defining an operating volume and having a central axis; and a base connected to the tube, the base comprising: a process fluid inlet having a plurality of outlet apertures or an annular aperture in fluid communication with the operating volume of the tube, wherein each of the plurality of outlet apertures or an annular aperture is spaced radially from the central axis of the tube.

In use, process fluid (or mobile phase) flows into the operating volume of the tube through the process fluid inlet (i.e. via/through the plurality of outlet apertures or the annular aperture).

By providing an expanded bed chromatography apparatus having a plurality of outlet apertures or an annular aperture (e.g. single annular aperture) for process fluid spaced radially from the central axis of the tube, the flow of the process fluid/mobile phase through the expanded bed chromatography apparatus may more effectively overcome drag at the interior surface of the tube because upward flow exiting the outlet apertures is spaced towards the interior surface of the tube. This may result in a more uniform radial flow profile (i.e. the flow profile between the central axis and the tube wall) and thereby reduce slower flow of the process fluid at the interior surface of the tube caused by wall friction and higher void volumes in the expanded bed media proximate the interior surface of the tube relative to the centre of the tube. This may also promote a uniform tight band of process fluid during elution which reduces contamination of the target product with unwanted components of the process fluid and improves the concentration of the target product output from the apparatus. Moreover, the mobile phase may more easily move through the stationary phase proximate the interior surface of the tube to promote good adsorption of the target product to the stationary phase. Further, the flow of the mobile phase may pass through a greater transverse cross-sectional area of the particulate media (including the stationary phase) at the bottom of the tube proximate the base, thus making more efficient use of the expensive particulate media within the tube and increasing the amount of expanded bed media capable of interacting with the target product which may allow the amount of target product passing through the apparatus during a particular use to be increased.

Optional features will now be set out. These are applicable singly or in any combination with any aspect.

The base may have a base central axis. The base may comprise a top (inner) surface substantially perpendicular to the base central axis. The top/inner surface is configured to face the operating volume of the tube i.e. the top surface comprises the plurality of outlet apertures or the annular aperture.

A base mesh layer may be provided adjacent the base. The base mesh layer may overlie the top/inner surface of the base such that it is interposed between the base and the operating volume of the tube. The base mesh layer may be planar and may lie substantially parallel to the top/inner surface of the base.

The base mesh layer may be dimensioned to cover the plurality of outlet apertures/annular aperture and it may cover substantially all of the top/inner surface of the base.

The base mesh layer may be formed of a metal material e.g. stainless steel or a plastics material such as polypropylene or polyethylene. The plastics material may be hydrophobic. The base mesh layer may have a mesh size of between 20 and 60 microns, such as between 30 and 50 microns or between 35 and 45 microns, for example around 40 microns.

The base mesh layer may be connected to (e.g. welded to) or mounted on a base sealing ring at its outer perimeter for sealing against the base and/or tube. The base sealing ring may be formed of a plastics material, for example an elastomer such as ethylene propylene diene monomer (EDPM). The plastics material is preferably biocompatible and most preferably a plastics material which is USP VI certified.

The base sealing ring may be an o-ring having a substantially circular transverse cross section (parallel to the axis of the tube). The base sealing ring may seal against the tube and/or against the base,

The base sealing ring may have a radially inner flange which may be substantially planar (i.e. a disc shaped radially inner flange) and the base mesh layer may be connected to (e.g. welded to) or mounted within the radially inner flange. It may additionally or alternatively have a radially outer flange which may be substantially planar (i.e. a disc shaped radially outer flange) and the radially outer flange may seal against the tube.

The base mesh layer may be removably attached to the base sealing ring so that the base mesh layer can be replaced.

There may also be provided a base mesh support layer.

The base mesh support layer may overlie the top/inner surface of the base such that it is interposed between the base and the base mesh layer. The base mesh support layer may be planar and may lie substantially parallel to the top/inner surface of the base.

The base mesh support layer may be dimensioned to cover the plurality of outlet apertures/annular aperture and it may cover substantially all of the top/inner surface of the base.

The base mesh support layer may be formed of a metal material e.g. stainless steel or a plastics material such as polypropylene or polyethylene. The plastics material may be hydrophobic. The base mesh support layer may have a greater mesh size than the base mesh layer. For example, the mesh support layer may have a mesh size of between 80 and 120 microns, such as between 90 and 110 microns or between 95 and 105 microns, for example around 100 microns.

The base mesh layer and base mesh support layer may have the same dimensions e.g. same radius.

The base central axis may be collinear with the central axis of the tube. In other words, the plurality of outlet apertures or the annular aperture may be spaced radially from the base central axis. When the base central axis is collinear with the central axis of the tube, the features of any aspect which are defined in relation to the central axis of the tube may also be defined in the same way in relation to the base central axis.

In some embodiments, each outlet aperture of the plurality of outlet apertures is equally spaced from the central axis of the tube/base i.e. all of the plurality of outlet apertures are spaced from the central axis of the tube/base by the same (first) radial spacing. Alternatively, one of the plurality of outlet apertures may be radially spaced from the central axis of the tube/base by a greater (first) radial spacing than one or more of the other outlet apertures.

In embodiments having an annular aperture, the annular aperture may be a portion of an annulus, or the annular aperture may be a complete annulus. In embodiments having an annular aperture, each part of the annular aperture is radially spaced (i.e. equally spaced) from the base/tube central axis such that the annular aperture is spaced radially from the central axis of the tube (i.e. the annular aperture surrounds the base/tube central axis).

The process fluid inlet may have two or more outlet apertures in fluid communication with the operating volume of the tube. Each of the two or more outlet apertures is spaced radially (e.g. equally spaced) from the central axis of the tube. The process fluid inlet may, for example, have three or more outlet apertures in fluid communication with the operating volume of the tube. Each of the three or more outlet apertures is spaced radially (e.g. equally spaced) from the central axis of the tube. The process fluid inlet may, for example, have four, five, six or more outlet apertures in fluid communication with the operating volume of the tube. Each of the four, five, six or more outlet apertures is spaced radially (e.g. equally spaced) from the central axis of the tube.

By providing, for example, three or more outlet apertures in fluid communication with the operating volume of the tube, the flow of the mobile phase through the tube may be optimised to achieve a more uniform radial flow profile. Further, formation of vortices in the flow through the tube may be reduced whilst still achieving efficient mixing. In other words, the selected number of outlets may form an anti-vortex feature.

In particular, the number of the plurality of outlet apertures may be selected to be operable to reduce the formation of vortices when used with a known vortex inhibiting feature at an end of the tube opposite the base. For example, the vortex-inhibiting structure described in WO2014/125304.

Accordingly, the apparatus may comprise a vortex inhibiting feature at an end of the tube opposite the base. For example, the vortex inhibiting structure described in WO2014/125304.

The plurality of outlet apertures may be spaced (e.g. substantially evenly spaced) circumferentially about the central axis of the tube (i.e. the plurality of outlet apertures may be located around one or more circles centred about the central axis of the tube). In some embodiments, a plurality of radii of the tube along which each of the plurality of outlet apertures may be respectively located, may be spaced by substantially the same angle about the central axis of the tube. For example, in embodiments having two outlet apertures, the outlet apertures may be circumferentially spaced by about 180 degrees i.e. the two outlet apertures may be located along a diameter of the tube, on opposite sides of the tube central axis. In alternative embodiments having three outlet apertures, the outlet apertures may be circumferentially spaced by about 120 degrees i.e. the three outlet apertures are respectively located along three radii of the tube which are about 120 degrees apart about the central axis of the tube. In alternative embodiments having four outlets, the outlets may be circumferentially spaced by about 90 degrees.

By providing a plurality of outlet apertures which are substantially evenly circumferentially spaced about the central axis of the tube, a uniform flow profile across the cross-section of the tube may be optimised i.e. plug flow may be optimised in the flow of mobile phase in the tube. Thus, a tight uniform band of process fluid may be maintained as the process fluid (mobile phase) flows up the tube. This may reduce contamination of the target product with unwanted components of the process fluid when the target product is eluted and increase target product concentration, purity and recovery.

The plurality of outlet apertures may be each located proximate an interior surface of the tube wall. In other words, each of the plurality of outlet apertures may be radially spaced from the central axis of the tube by the first radial spacing which is greater than the radial spacing of the outlet apertures from the tube wall.

By locating the plurality of outlet apertures proximate the interior surface of the tube wall, the flow of the mobile phase may pass through more of the particulate media (the stationary phase) at the bottom of the tube proximate the base, thus making more efficient use of the expensive particulate media proximate the tube. Moreover, the mobile phase may more easily move through the stationary phase proximate the interior surface of the tube to promote increased adsorption of the target product to the stationary phase. For example, hold-up of process fluid may be prevented because the flow of the mobile phase may more effectively overcome drag at the interior surface of the tube wall. This may reduce slower flow of the process fluid at the interior surface of the tube caused by wall friction and higher void volumes in the expanded bed media proximate the interior surface of the tube relative to the centre of the tube

In alternative embodiments, the plurality of outlet apertures may be each located proximate the central axis of the tube. In other words, the first radial spacing may be less than the radial spacing of the outlet apertures from the tube wall. In alternative embodiments, the first radial spacing may be equal to the radial spacing of the outlet apertures from the tube wall.

There may be two or more sets of outlet apertures. Each set may be spaced from the central axis of the tube by a different radial spacing. For example, a first set of outlet apertures may be radially spaced from the central axis of the tube by the first radial spacing and a second set outlet apertures may be radially spaced from the central axis of the tube by a second radial spacing, wherein the second radial spacing is greater than the first radial spacing. In other words, the first set of outlet apertures may circumscribe a first circle (having a radius matching the first radial spacing), centred about the central axis of the tube, and the second set of outlet apertures may circumscribe a second circle (having a radius matching the second radial spacing), centred about the central axis of the tube.

Further sets of outlet apertures may be provided which may circumscribe one or more further circles which have a radius different to the first radial spacing and the second radial spacing.

The process fluid inlet may comprise an inlet conduit extending from an inlet aperture and in fluid communication with the outlet apertures. The inlet conduit may divide at a conduit junction to form a plurality of outlet portions, each of the plurality of outlet portions corresponding to and in fluid communication with a respective one of the plurality of outlet apertures.

In embodiments having an annular aperture, the process fluid inlet may comprise an outlet portion in fluid communication with the annular aperture and the inlet aperture, e.g. a single outlet portion in fluid communication with a single annular aperture. The outlet portion may align with the base/tube central axis. The base may comprise a recess e.g. over the outlet portion. The base may comprise a circumferential distributor located in the recess in the base. The circumferential distributor is configured to partly define the annular aperture in the base e.g. to define the radially inner circumference of the annular aperture.

The circumferential distributor may have a width/diameter which is smaller than a width/diameter of the recess in the base such that an annular aperture is formed between the edge of the recess and the circumferential distributor. In other words, the base may comprise an annular aperture surrounding the circumferential distributor wherein the annular aperture is in fluid communication with the inlet conduit. In use, process fluid flows from the inlet conduit, around the circumferential distributor and out of the annular aperture into the operating volume.

The circumferential distributor may be removably connected (e.g. threadedly connected) to the base i.e. the recess in the base may comprise a threaded portion for mutual engagement with a threaded portion on the circumferential distributor. In alternative embodiments, the circumferential distributor may be integrally formed with the base.

The circumferential distributor may comprise an upper portion which may be flared such that the diameter of the circumferential distributor is greater proximal the annular aperture than the diameter proximate the inlet conduit. The upper portion may protrude above the top surface of the base.

The circumferential distributor may a plurality of support members e.g. support members extending from the upper flared portion into the recess. There may be a gap between each support member in a circumferential direction to allow fluid to flow between the support members. In use, fluid flows through the outlet portion, between the support members and into the operating volume of the expanded bed chromatography apparatus through the annular aperture.

The upper portion of the circumferential distributor be a flat disc e.g. circular disc. The transverse cross sectional shape of the recess may be similar to the transverse cross sectional shape of the cover e.g. circular.

An inner surface of the inlet conduit may be polished (e.g. an inner surface of one or more of the outlet portions may be polished).

The base or a portion of the base may be transparent. The base or a portion of the base may be transparent such that the inlet conduit (or a part of the inlet conduit) is visible to a user. The base or a portion of the base may be transparent such that the conduit junction is visible to a user.

The base may be plastic (i.e. the base may be made from a polymer material). For example, the base may comprise acrylic plastic (i.e. polymethyl methacrylate) or other plastic e.g. polypropylene or polycarbonate.

The base may be removably connected to the tube. The tube may abut the base such that the bottom end of the tube is closed by the base. The base and the tube may be removable from the apparatus and replaceable such that the base and the tube are single-use components.

By providing the tube which abuts the base such that the bottom end of the tube is closed by the base, the contents of the operating volume of the tube (e.g. the process fluid and the expanded bed of particulate media) may only come into contact with the base and the tube at the bottom of the apparatus. Accordingly, when reusing the chromatography apparatus, only the base and the tube need to be replaced and all other components at the bottom of the apparatus may be reused as they do not come into contact with the contents of the operating volume of the tube.

There may be a connecting member proximate (e.g. surrounding) the connection between the tube (i.e. the tube wall) and the base (e.g. surrounding the abutment between the tube and the base). The connecting member may be a flange (e.g. an annular flange/circular disc). The connecting member may circumscribe the base. The tube and/or the base may be removably connected to the connecting member (e.g. via a friction fit, a threaded hole or an o-ring). The connecting member may extend beyond a side surface of the base (i.e. the connecting member may overhang the base).

The base may comprise a side surface transverse to the top surface. The base may be configured to allow a magnetic stirring device to be located underneath the base. For example, the inlet aperture may be provided in the side surface of the base. In other words, the inlet aperture may be formed in a surface of the base which is transverse to the top/inner surface of the base which faces the operating volume of the apparatus.

By providing the inlet aperture at a side surface transverse to the top surface of the base, as opposed to a bottom (outer) surface of the base opposite the top surface, the inlet aperture does not interfere with the positioning of a magnetic stirring device underneath the base. Advantageously, an off-the-shelf magnetic stirring device may be used with the apparatus which can be positioned underneath the base in use without the need for adaptation of the magnetic stirring device to avoid an inlet aperture at the underside of the base (i.e. an inlet aperture at the bottom/outer surface of the base). Moreover, a single off-the-shelf magnetic stirring device may be used with multiple other apparatus according to the first aspect

The apparatus may comprise a shelf configured to support a magnetic stirring device. The shelf may be located below the base (i.e. below the bottom/outer surface, opposite the tube). The shelf may be attached to the apparatus via the connecting member. The shelf may be adjustable such that a gap between the base and the shelf is adjustable.

Magnetic stirring devices are configured to generate a rotating magnetic field. The rotating magnetic field may be caused by a rotating component such as a magnet or an electromagnet. The rotating magnetic field may rotate about a rotation axis of the magnetic stirring device.

The apparatus (e.g. the shelf) may comprise an alignment feature configured to align the magnetic stirring device with the base and/or apparatus. The apparatus may comprise an alignment feature configured to align the magnetic stirring device with the central axis of the tube. Alternatively, or in addition, the apparatus may comprise an alignment feature configured to align the magnetic stirring device with the base central axis. The alignment feature may align the magnetic stirring device with the tube such that the rotation axis of the magnetic stirring device is collinear with the central axis of the tube. Alternatively, or in addition, the alignment feature may align the magnetic stirring device with the base such that the rotation axis of the magnetic stirring device is collinear with the base central axis.

By providing an alignment feature, when the magnetic stirring device is used with a corresponding rotatable magnetic stirring component (see below) located in the tube, the rotatable magnetic stirring component may be maintained in a desired location within the tube. For example, when the rotation axis of the magnetic stirring device and the central axis of the tube are collinear, the rotatable magnetic stirring component may be maintained in alignment with the central axis of the tube.

The tube may be configured to receive a rotatable magnetic stirring component (which may be referred to as a flea). The rotatable magnetic stirring component (hereinafter referred to as the “magnetic stirrer”) may be a bar e.g. an elongate bar. Alternatively, the magnetic stirrer may be a sphere, an ovoid, a cruciform shape or a disc with radially extending spokes. In fact, the magnetic stirrer may be any known shape of magnetic stirrer suitable for use with a magnetic stirring device. The magnetic stirrer is configured to magnetically couple with a magnetic stirring device used with the apparatus. For example, a magnetic stirring device supported by the shelf.

The magnetic stirrer may comprise a permanent magnet. For example, the magnetic stirrer may comprise a permanent neodymium magnet or other permanent rare-earth magnet. In other embodiments, the magnetic stirrer may comprise a ferro-magnet. The magnetic stirrer is configured to rotate under influence of a magnetic stirring device. For example, the magnetic stirrer is configured to rotate under influence of a magnetic stirring device located on the shelf.

By providing an expanded bed chromatography apparatus where the flow in the tube is stirred using a rotatable magnetic stirring component in combination with a magnetic stirring device which provides the motive force and can couple with the rotatable magnetic stirring component, contamination of the contents within the tube may be reduced. For example, unlike prior art devices, no opening needs to be provided in the tube or base to allow a stirring device to access the operating volume of the tube. This may reduce the number of sites liable to contamination and thus may reduce the likelihood of external contamination of the process fluid and the target product eluted from the apparatus. Further, the rotatable magnetic stirring component may be removed and replaced with an alternative rotatable magnetic stirring component to suit a desired application and/or to reduce contamination between different uses of the apparatus. For example, the rotatable magnetic stirring component may be replaced each time the apparatus is used.

A part of the magnetic stirrer may sweep over one or more of the plurality of outlet apertures or a respective portion of one or more of the plurality of outlet apertures. A part of the magnetic stirrer may sweep over the annular aperture or a portion of the annular aperture. For example, the magnetic stirrer may have a maximum dimension greater than twice the first radial spacing. Alternatively, the magnetic stirrer may be located over a region of the base between the plurality of outlet apertures and the central axis of the tube/base. For example, the magnetic stirrer may have a maximum dimension which is less than or equal to twice the first radial spacing. In other words, the magnetic stirrer may not sweep over the plurality of outlet apertures or the annular aperture. The axis of rotation of the magnetic stirrer may be aligned with the central axis of the tube/base.

By providing a magnetic stirrer wherein only a portion sweeps over the plurality of outlet apertures or which does not sweep over the plurality of outlet apertures (e.g. by providing a magnetic stirrer aligned with the central axis of the tube/base and a plurality of outlet apertures spaced radially from the central axis of the tube/base), the magnetic coupling of the magnetic stirrer with the magnetic stirring device may be less disrupted by the flow of the mobile phase/process fluid from the plurality of outlet apertures into the operating volume of the tube. In other words, the flow of the mobile phase from the plurality of outlet apertures is less likely to decouple the magnetic coupling between the magnetic stirrer and the magnetic stirring device.

The conduit junction may also comprise a flow distributor. For example, the flow distributor may be located within the conduit junction i.e. the flow distributor may be a component separate from the structure of the conduit junction. The flow distributor may be movable within the conduit junction. The flow distributor may be a ball bearing. The flow distributor may be a magnetic flow distributor for use with the magnetic stirring device (e.g. the flow distributor may comprise a permanent magnet). The conduit junction may be aligned with central axis of the tube.

By providing a flow distributor at the conduit junction, the flow in the inlet conduit may be more evenly distributed between the plurality of outlet portions and thus between the plurality of outlet apertures. In other words, the flow distributor may reduce preferential flow through one or more of the plurality of outlet portions. As a result, flow through the tube may be advantageously more uniform across the cross-section of the tube (i.e. plug flow may be promoted in the flow through the tube). Additionally, by providing a flow distributor which is a magnetic flow distributor, the magnetic flow distributor may be movable under influence of a magnetic stirring device and thus the even distribution of mobile phase flow between the outlet portions may be improved (i.e. preferential flow through one or more of the plurality of outlet portions may be reduced).

In a second aspect, there is provided an expanded bed chromatography system comprising: an expanded bed chromatography apparatus according to the first aspect; a magnetic stirring device located underneath the base of the expanded bed chromatography apparatus; and a rotatable magnetic stirring component received in the tube of the expanded bed chromatography apparatus and configured to magnetically couple with the magnetic stirring device such that the rotatable magnetic stirring component is rotatable under influence of the magnetic stirring device.

Advantageously, the content (i.e. the mobile phase and the stationary phase) in the operating volume of the expanded bed chromatography apparatus in the system according to the second aspect may be effectively stirred using a rotatable magnetic stirring component (hereinafter referred to as the “magnetic stirrer”) under the influence of the magnetic stirring device. In contrast to existing expanded bed chromatography apparatus which require apertures to allow access to the operating volume of the apparatus in order to provide components to facilitate stirring (such as a motor driven shaft), the expanded bed chromatography system according to the second aspect may have a reduced number of sites liable to contamination and thus may reduce the likelihood of external contamination of the process fluid and the target product eluted from the apparatus. Further, components of the expanded bed adsorption system which implements a magnetic stirring device and rotatable magnetic stirring component are advantageously removable and replaceable. The magnetic stirrer may be removed and replaced with an alternative magnetic stirrer to suit a desired application and/or to reduce contamination between different uses of the apparatus. For example, the magnetic stirrer can be easily removed and replaced with an alternative magnetic stirrer having a different shape and/or size.

The magnetic stirring device and magnetic stirrer may be as described above for the first aspect.

In a third aspect there is provided an expanded bed chromatography apparatus base having a base central axis, the base comprising: a top/inner surface perpendicular to the base central axis, wherein the base comprises a process fluid inlet having a plurality of outlet apertures or an annular aperture in the top surface of the base for fluid communication with an operating volume of a tube of an expanded bed chromatography apparatus, wherein each of the plurality of outlet apertures or the annular aperture is spaced radially from the base central axis.

In use (e.g. when connected to a tube of an expanded bed chromatography apparatus), the base central axis may be collinear with the central axis of the tube of an expanded bed chromatography apparatus. In these embodiments, the plurality of outlet apertures or the annular aperture may be spaced radially from the central axis of the tube.

In use (e.g. when connected to a tube of an expanded bed chromatography apparatus), process fluid (or mobile phase) flows into the operating volume of the expanded bed chromatography apparatus tube through the process fluid inlet (i.e. via/through the plurality of outlet apertures or the annular aperture)

The base, process fluid inlet and plurality of outlet apertures/annular aperture may be as described above in relation to the first aspect. There may be a base mesh layer, base sealing ring and base mesh support layer as described for the first aspect.

In a fourth aspect there is a provided an expanded bed chromatography system comprising: an expanded bed chromatography apparatus comprising: a tube defining an operating volume and having a central axis; and a base connected to the tube, the base comprising a top/inner surface facing the operating volume and a transverse side surface, the base further comprising a process fluid inlet having an inlet aperture in the side surface and an outlet aperture in the top surface in fluid communication with the operating volume of the tube wherein the outlet aperture is spaced radially from the central axis of the tube; the expanded bed chromatography system further comprising: a magnetic stirring device located underneath the base of the expanded bed chromatography apparatus; and a rotatable magnetic stirring component received in the tube of the expanded bed chromatography apparatus and configured to magnetically couple with the magnetic stirring device such that the rotatable magnetic stirring component is rotatable under influence of the magnetic stirring device.

In use, process fluid (or mobile phase) flows into the operating volume of the tube through the process fluid inlet (i.e. via/through the outlet aperture).

Advantageously, the content (i.e. the mobile phase and the stationary phase) in the operating volume of the expanded bed chromatography apparatus in the system according to the fourth aspect may be effectively stirred using a rotatable magnetic stirring component (a “magnetic stirrer”) under the influence of the magnetic stirring device. In contrast to existing expanded bed chromatography apparatus which require apertures to allow access to the operating volume of the apparatus in order to provide components to facilitate stirring (such as a motor driven shaft), the expanded bed chromatography system according to the fourth aspect may have a reduced number of sites liable to contamination and thus may reduce the likelihood of external contamination of the process fluid and the target product(s) output from the apparatus. Further, components of the expanded bed adsorption system which implements a magnetic stirring device and magnetic stirrer are advantageously removable and replaceable. The magnetic stirrer may be removed and replaced with an alternative magnetic stirrer to suit a desired application and/or to reduce contamination between different uses of the apparatus. For example, the magnetic stirrer can be easily removed and replaced with an alternative magnetic stirrer having a different shape.

Moreover, by providing the inlet aperture at a side surface, transverse to the top surface of the base, as opposed to a bottom surface of the base opposite the top surface, the inlet aperture does not interfere with the positioning of a magnetic stirring device underneath the base. Advantageously, an off-the-shelf magnetic stirring device may be used with the apparatus which can be positioned underneath the base in use without the need for adaptation of the magnetic stirring device to avoid an inlet aperture at the underside of the base.

The base may have a base central axis. The top surface is substantially perpendicular to the base central axis. The base may have a bottom/outer surface axially opposite the top surface.

The base central axis may be collinear with the central axis of the tube. In other words, the outlet aperture may be spaced radially from the base central axis. When the base central axis is collinear with the central axis of the tube, the features of the fourth aspect which are defined in relation to the central axis of the tube may also be defined in the same way in relation to the base central axis.

The outlet aperture may be located proximate the interior surface of the tube wall. In other words, the outlet aperture may be radially spaced from the central axis of the tube by a greater radial spacing than the radial spacing from the tube (i.e. the interior surface of the tube wall).

The outlet aperture may be an annular aperture. There may be only a single annular aperture. The annular aperture may be a portion of an annulus, or the annular aperture may be a complete annulus. In embodiments having an annular aperture, each part of the annular aperture is radially spaced from the base/tube central axis (i.e. equally spaced from the central axes) such that the annular aperture is spaced radially from the central axis of the tube (i.e. the annular aperture surrounds the base/tube central axis).

The outlet aperture may be spaced from the central axis of the tube/base by a first radial spacing. A part of the magnetic stirrer may sweep over the outlet aperture or a portion of the outlet aperture. For example, the magnetic stirrer may have a maximum dimension greater than twice the first radial spacing. Alternatively, the magnetic stirrer may be located over a region of the base between the outlet aperture and the central axis of the tube/base. For example, the magnetic stirrer may have a maximum dimension which is less than or equal to twice the first radial spacing. In other words, magnetic stirrer may not sweep over the outlet aperture. The magnetic stirrer may be aligned with the central axis of the tube/base.

By providing a magnetic stirrer wherein only a part of the magnetic stirrer sweeps over the outlet aperture or which does not sweep over the outlet aperture (e.g. by providing a magnetic stirrer aligned with the central axis of the tube/base and an outlet aperture spaced radially from the central axis of the tube), the magnetic coupling of magnetic stirrer with the magnetic stirring device may be less disrupted by the flow of the mobile phase from the outlet aperture and into the operating volume of the tube. In other words, the flow of the mobile phase from the outlet aperture is less likely to decouple the magnetic coupling between the magnetic stirrer and the magnetic stirring device.

The apparatus may comprise a shelf configured to support a magnetic stirring device. The shelf may be as described above for the first aspect.

The apparatus (e.g. the shelf) may comprise an alignment feature configured to align the magnetic stirring device with the base and/or apparatus as described above for the first aspect.

The magnetic stirrer may be as described in relation to the first aspect.

The process fluid inlet may comprise an inlet conduit in fluid communication with the inlet aperture and the outlet aperture. The inlet conduit may comprise an outlet portion corresponding to and in fluid communication with the outlet aperture.

In embodiments wherein the outlet aperture is an annular aperture, the base may comprise a circumferential distributor as described in relation to the first aspect. In embodiments having the circumferential distributor, the base may be as described in relation to embodiments of the first aspect having a circumferential distributor.

An inner surface of the inlet conduit may be polished (e.g. the inner surface of the outlet portion may be polished).

The base may be as described above for the first aspect. There may be a base mesh layer, base sealing ring and base mesh support layer as described for the first aspect.

A connecting member may be provided proximate (e.g. surrounding) the connection between the tube and the base as described above for the first aspect.

There may be a plurality of outlet apertures as described above in relation to the first aspect. For example, in some embodiments, the process fluid inlet may comprise a plurality of outlet apertures in the top surface of the base and in fluid communication with the operating volume of the tube wherein each of the plurality of outlet apertures is spaced radially from the central axis of the tube. The process fluid inlet may be as described above for the first aspect e.g. the inlet conduit may divide at a conduit junction to form a plurality of outlet portions, each of the plurality of outlet portions corresponding to and in fluid communication with a respective one of the plurality of outlet apertures. The conduit junction may comprise a flow distributor as described above for the first aspect.

In a fifth aspect, there is a provided an expanded bed chromatography apparatus for use with the expanded bed chromatography system according to the fourth aspect.

The expanded bed chromatography apparatus according to the fifth aspect comprises: a tube defining an operating volume and having a central axis; and a base connected to the tube, the base comprising: a top surface facing the operating volume and a transverse side surface, the base further comprising a process fluid inlet having an inlet aperture in the side surface and an outlet aperture in the top surface in fluid communication with the operating volume of the tube, wherein the outlet aperture is spaced radially from the central axis of the tube.

The expanded bed chromatography apparatus according to the fifth aspect may be advantageously used with a magnetic stirring device and a magnetic stirrer such that the content of the operating volume may be effectively stirred using the magnetic stirrer under the influence of the magnetic stirring device. In contrast to existing expanded bed chromatography apparatus which require apertures to allow access to the operating volume of the apparatus in order to provide components to facilitate stirring (such as a motor driven shaft), the expanded bed chromatography apparatus according to the fifth aspect may have a reduced number of sites liable to contamination and thus may reduce the likelihood of external contamination of the process fluid and the target product eluted from the apparatus.

Moreover, by providing the inlet aperture at a side surface, transverse to the top surface of the base, as opposed to a bottom surface of the base opposite the top surface, the inlet aperture does not interfere with the positioning of a magnetic stirring device underneath the base. Advantageously, an off-the-shelf magnetic stirring device may be used with the apparatus which can be positioned underneath the base in use without the need for adaptation of the magnetic stirring device to avoid an inlet aperture at the underside of the base.

The expanded bed chromatography apparatus may be as described above in relation to the fourth aspect.

In a sixth aspect, there is a provided an expanded bed chromatography apparatus base for use with the expanded bed chromatography system according to the fourth aspect.

The expanded bed chromatography apparatus base according to the sixth aspect comprises: a top surface facing the operating volume and a transverse side surface, the base further comprising a process fluid inlet having an inlet aperture in the side surface and an outlet aperture in the top surface in fluid communication with the operating volume of the tube, wherein, in use, the outlet aperture is configured to be spaced radially from the central axis of the tube.

The base may comprise a base central axis. The top surface may be perpendicular to the base central axis. The outlet aperture may be spaced radially from the base central axis. In use (i.e. when connected to a tube of an expanded bed chromatography apparatus), the base central axis may be collinear with the central axis of a tube of an expanded bed chromatography apparatus.

The expanded bed chromatography apparatus base may be as described above in relation to the fourth aspect.

In this specification, “tube” refers to an open-ended tube. The open-ended tube is closed by end-retaining structures. The base is an end-retaining structure at the bottom of the tube. The end-retaining structure at the top of the tube (i.e. the end opposite the base and opposite the lower end of the tube) may be a fixed cap having an exit port. The end-retaining structure at the top of the tube may be plastic. For example, the end-retaining structure at the top of the tube may comprise acrylic plastic (i.e. polymethyl methacrylate).

The end-retaining structure e.g. cap may comprise a top mesh layer, top support ring and top mesh support layer. Their structure and materials may be as described for the base mesh layer, base support ring and base mesh support layer.

The top mesh layer may be provided adjacent the end-retaining structure e.g. cap. The top mesh layer may overlie an operating surface of the end-retaining structure/cap which in use is configured to face the operating volume of the tube such that it is interposed between the operating volume of the tube and the operating surface. The top mesh layer may be planar and may lie substantially perpendicular to the central axis of the tube.

The top mesh layer may be dimensioned to overlie the exit port and it may overlie substantially all of the operating surface of the end-retaining structure/cap.

The material and mesh size of the top mesh layer may be as described for the base mesh layer.

There may be a top sealing ring which may be as described for the base sealing ring for sealing against the tube and/or the end-retaining structure/cap.

There may also be provided a top mesh support layer.

The top mesh support layer may overlie the operating surface of the end-retaining structure/cap such that it is interposed between the operating surface and the top mesh layer. The top mesh support layer may be planar and may lie substantially perpendicular to the central axis of the tube.

The top mesh support layer may be dimensioned to overlie the exit port and it may overlie substantially all of the operating surface of the end-retaining structure/cap.

The material and mesh size of the top mesh support layer may be as described for the base mesh support layer.

The end-retaining structure e.g. cap may comprise a vortex inhibiting feature such as the vortex inhibiting structure described in WO2014/125304. The vortex inhibiting feature may be connected (e.g. threadedly connected) to the end-retaining structure e.g. cap proximate the exit port. In use, the vortex inhibiting feature may extend from the fixed cap into the operating volume of the chromatography apparatus in which case any top mesh layer, top support ring and top mesh support layer will be downstream of the vortex inhibiting feature.

In a seventh aspect there is provided an expanded bed chromatography apparatus cap for closing an expanded bed chromatography apparatus tube, the expanded bed chromatography apparatus cap comprising: an exit port, an operating surface which in use is configured to face the operating volume of an expanded bed chromatography apparatus, wherein the operating surface spans an operating surface width and wherein the expanded bed chromatography apparatus cap has a maximum thickness between the operating surface and an opposing top surface. The maximum thickness is measured in a direction parallel to the central axis of the cap.

The maximum thickness may be a multiple of the operating surface width wherein that multiple is between about 0.2 and about 2, more preferably between about 0.25 and about 1.5, more preferably between about 0.3 and about 1, more preferably between about 0.35 and about 0.9, more preferably between about 0.4 and about 0.8, more preferably between about 0.45 and about 0.7, more preferably between about 0.5 and about 0.6.

For example, the thickness may be about one half of the operating surface width (i.e. the tube inner diameter).

The cap may have a central axis which in use may align with the central axis of the expanded bed chromatography apparatus tube. The operating surface of the cap may be inclined at an angle to the central axis of the cap. The operating surface may be a concave cone which directs fluid to the exit port. The operating surface may be inclined from the periphery of the fixed cap to the exit port.

The exit port may be aligned with the central axis of the cap. The operating surface may converge (e.g. upwardly converge) towards the exit port e.g. the operating surface may be a concave (e.g. conical) surface converging to the exit port.

The operating surface width may be perpendicular to the central axis of the cap. In other words, in embodiments wherein the operating surface is inclined at an angle to the central axis of the cap, the operating surface width may be measured perpendicular to the central axis of the cap from one peripheral point of the operating surface to the opposite peripheral point on the operating surface. For example, where the operating surface is a concave cone, the operating surface width is the largest diameter of that cone (i.e. the cone base). In use, the operating surface width may be equivalent to the inner diameter of the expanded bed adsorption chromatography tube.

The expanded bed chromatography cap of the seventh aspect may have a connecting surface which is configured to abut the top of the expanded bed chromatography tube. The periphery of the operating surface may extend to the connecting surface of the cap.

The exit port may have an exit port diameter. The exit port diameter may be the largest diameter of the exit port. i.e. a full bore.

Alternatively or additionally, the maximum thickness of the cap may be a multiple of the exit port diameter wherein that multiple is between about 0.8 and about 5, more preferably between about 1 and about 4.5, more preferably between about 1.2 and about 4, more preferably between about 1.4 and about 3.5, more preferably between about 1.6 and about 3, more preferably between about 1.8 and about 2.5, more preferably between about 1.9 and about 2.

The exit port may comprise an exit port conduit which extends (upwardly in use) away from a top surface of the fixed cap. In use, the exit port conduit is in fluid communication with the operating volume of the expanded bed chromatography apparatus. The top surface of the fixed cap may be transverse to (e.g. substantially perpendicular to) the central axis of the cap.

A portion of the exit port conduit may be removable from the fixed cap. The removable portion of the exit port conduit may be replaceable. The removable portion of the exit port conduit may be connected e.g. threadedly connected to the fixed cap. The removable portion of the exit port conduit may be a different material (e.g. polypropylene) to the material of the fixed cap (e.g. acrylic plastic). The fixed cap may be acrylic (e.g. transparent acrylic) plastic (PMMA). The removable portion of the exit port conduit may be a stronger material than acrylic.

The fixed cap may comprise a vortex inhibiting feature such as the vortex inhibiting structure described in WO2014/125304. The vortex inhibiting feature may be connected (e.g. threadedly connected) to the fixed cap proximate the exit port. In use, the vortex inhibiting feature may extend from the fixed cap into the operating volume of the chromatography apparatus.

The fixed cap may be engageable with the tube of the expanded bed chromatography apparatus. The fixed cap may comprise an engaging feature configured to engage the fixed cap with the tube. The engaging feature may comprise a seal e.g. an o-ring, a flat/seal gasket, or a tri-clamp seal/gasket.

The fixed cap may comprise fixing/fastener apertures. The fixing/fastener apertures may be in the top surface of the cap. The fixing/fastener apertures may extend through the fixed cap radially spaced from the periphery of the operating surface. For example, the fixing/fastener apertures may extend from the top surface of the fixed cap to an overhanging surface at the periphery of the operating surface which extends radially from the cap. The fixing/fastener apertures may be at the periphery of the fixed cap e.g. spaced radially from the central axis of the cap further than the spacing of the engaging feature from the central axis of the cap. The fixing/fastener apertures are configured to receive fixing/fastener members e.g. rods, bolts such that the fixed cap may be fixed/fastened to the expanded bed chromatography apparatus. The fixing/fastener apertures may be the same as or have one or more features of the fixing/fastener apertures described in the eighth aspect.

The fixed cap may be removable and replaceable from the expanded bed chromatography apparatus such that the fixed cap is single use. Accordingly, contamination of the apparatus from one use to the next may be reduced.

The fixed cap may comprise a top mesh layer, top sealing ring and top mesh support layer as previously described.

In an eighth aspect there is provided an expanded bed chromatography apparatus cap comprising: an exit port, a liner for closing an expanded bed chromatography apparatus tube, the liner having an operating surface which in use is configured to face the operating volume of an expanded bed chromatography apparatus, and a support structure on a side of the liner opposite the operating surface, wherein the support structure is removably connected to the liner such that the support structure reinforces the liner.

By providing an expanded bed chromatography apparatus cap according to the eighth aspect, the support structure is isolated from the operating volume of the expanded bed chromatography apparatus tube when in use. This means that each time the apparatus is reused, the liner can be replaced but the same support structure reused to reinforce a new liner. It is also possible to replace the entire cap. Therefore, contamination of the apparatus from one use to the next may be reduced and the amount of disposable material may be reduced whilst retaining the required strength and integrity of the cap.

The support structure may overlay (e.g. fully overlay) an opposing surface of the liner which is opposite the operating surface.

The cap has a central axis. In use, the central axis of the cap may align with the central axis of the expanded bed chromatography apparatus tube. The operating surface of the cap may be inclined at an angle to the central axis of the cap. The operating surface may be a concave cone which directs fluid to the exit port.

The liner may have a conical shape. The concave interior of the conical shape may form the operating surface. The support structure may have a conical shape. The support structure may have a similar shape as the liner. For example, in some embodiments, the liner may have a conical shape and the support structure may have a similar conical shape. Accordingly, the concave interior of the support structure may face the convex exterior of the liner.

The support structure may comprise a frame (e.g. a reinforcing frame).

The liner may comprise a liner aperture which forms the exit port (e.g. part of the exit port). The operating surface may converge (e.g. upwardly converge) towards the liner aperture e.g. the operating surface may be a concave surface converging to the liner aperture. The liner aperture may be aligned with the central axis of the cap. The operating surface may be inclined from the periphery of the cap to the liner aperture.

The support structure may comprise a support structure aperture. The support structure aperture may be aligned with the central axis of the cap. A portion of the liner may extend through the aperture such that the portion of the liner lines the support structure aperture. The portion of the liner which lines the support structure aperture may form the exit port (e.g. part of the exit port). In other words, the liner aperture may align with and may be contained within the support structure aperture.

By providing a portion of the liner which lines the support structure aperture, an exit port may be formed in the cap without the support structure making contact with the process fluid flowing through the exit port when in use.

The liner may be a plastic material. For example, the liner may be polytetrafluoroethylene, polypropylene or polymethyl methacrylate. The support structure may be made from a different material than the liner. The support structure may be made from a metal such as steel e.g. stainless steel.

The liner and the support structure may be held together with one or more fixings or fasteners e.g. one or more bolts. The liner and/or the support structure may be attached to the tube of an expanded bed chromatography column with one more fixings or fasteners e.g. one or more bolts. In some embodiments, the fixings or fasteners that hold the liner and the support structure together are the same fixings or fasteners that attach the liner and/or the support structure to the tube.

In some embodiments, the liner and the support structure may comprise one or more fixing/fastener apertures. The one or more fixing/fastener apertures in the liner may align with the one or more fixing/fastener apertures in the support structure when the support structure is connected (e.g. overlays) the liner. The one or more fixing/fastener apertures may each be configured to receive a bolt to hold the liner and the support structure together. In some embodiments, the one or more fixing/fastener apertures may be configured to align with a flange of an expanded bed chromatography apparatus when in use. The fixing/fastener apertures may be the same as or have one or more features of the fixing/fastener apertures described in the seventh aspect.

The cap may further comprise an exit conduit. The exit conduit may be in fluid communication with the liner aperture such that the liner aperture and the exit conduit form the exit port of the cap. The exit conduit may be removably connected to the liner. The exit conduit may be removably connected to the liner aperture. For example, the liner aperture may comprise an internal thread and the exit conduit may comprise an external thread so that the exit conduit can be removably connected to the liner. A (EDPM) seal e.g. an o-ring, a flat seal/gasket or a tri-claim seal/gasket may be provided between the exit conduit and the liner. The exit conduit may have an exit conduit flange (e.g. a radially extending exit conduit flange) at an end opposite the liner.

The cap may comprise a vortex inhibiting feature such as the vortex inhibiting structure described in WO2014/125304. The vortex inhibiting feature may be connected (e.g. threadedly connected) to the cap proximate the liner aperture. In use, the vortex inhibiting feature may extend from the cap into the operating volume of the chromatography apparatus.

The cap may comprise a top mesh layer, top sealing ring and top mesh support layer as previously described, which overlie the operating surface of the liner. The invention includes the combination of the aspects and preferred features described except where such a combination is clearly impermissible or expressly avoided.

In the aspects of the invention described, the tube may have a wall thickness of between about 5 mm and about 40 mm, preferably between about 10 mm and about 30 mm, more preferably between about 10 mm and about 20 mm. In aspects of the invention described, the tube may have an inner diameter between about 20 mm and about 2000 mm, preferably between about 40 mm and about 2000 mm, more preferably between about 40 mm and about 1000 mm, more preferably between about 70 mm and about 600 mm, more preferably between about 80 mm and about 400 mm, more preferably between about 90 mm and 200 mm, such as about 100 mm.

In the aspects of the invention described, the inlet conduit may have a diameter of between about 6 mm and 50 mm, preferably between about 6 mm and about 14 mm, such as about 10 mm. The inlet conduit may have a varying diameter. For example, the outlet portions have a smaller diameter than the rest of the inlet conduit. For example, the outlet portions may be about 1 mm or about 2 mm or about 3 mm smaller in diameter. The outlet portions may have a diameter of between about 6 mm to about 14 mm, preferably between about 7 mm and 9 mm, such as about 8 mm.

In the aspects of the invention described, the depth of the base i.e. from the top/inner surface facing the operating volume of the tube towards the bottom/outer surface is such that the rotatable magnetic component remains coupled with the magnetic stirring device. For example, the depth of the base may be between 10 mm and 100 mm, for example between about 20 mm and 80 mm or between about 30 mm and about 70 mm.

### BRIEF DESCRIPTION OF THE DRAWINGS

Embodiments and experiments illustrating the principles of the invention will now be discussed with reference to the accompanying figures in which:

FIG. 1 is a cross-section of an expanded bed chromatography apparatus according to an embodiment of the present disclosure.

FIG. 2 is an enlarged view of a cross-section of the bottom of an expanded bed chromatography apparatus according to an embodiment of the present disclosure.

FIG. 3 shows a top view of the tube, connecting member (i.e. flange) and base of an expanded bed chromatography apparatus according to an embodiment of the present disclosure.

FIG. 4 shows a cross-section side view of a cap for an expanded bed chromatography apparatus according to an embodiment of the present disclosure.

FIG. 5 shows a cross-section side view of an alternative cap for an expanded bed chromatography apparatus according to an embodiment of the present disclosure.

FIG. 6 shows a cross-section side view of a further alternative cap for an expanded bed chromatography apparatus according to an embodiment of the present disclosure.

FIG. 7 shows a cross-section side view of a variation of the expanded bed chromatography apparatus base shown in FIGS. 1 to 3.

FIG. 8 shows a cross-section side view of a further variation of the expanded bed chromatography apparatus base shown in FIGS. 1 to 3 and 7.

FIG. 9 shows a cross-section side view of a further variation of the expanded bed chromatography apparatus base shown in FIGS. 1 to 3 and 8.

FIG. 10 shows a cross section of a base of the expanded bed chromatography apparatus with a base mesh layer, base sealing ring and base mesh support layer.

### DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

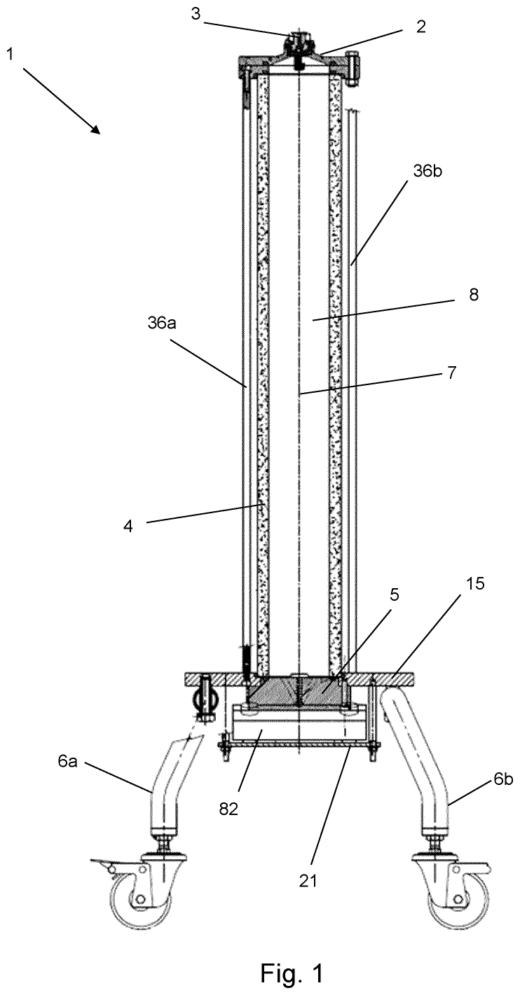

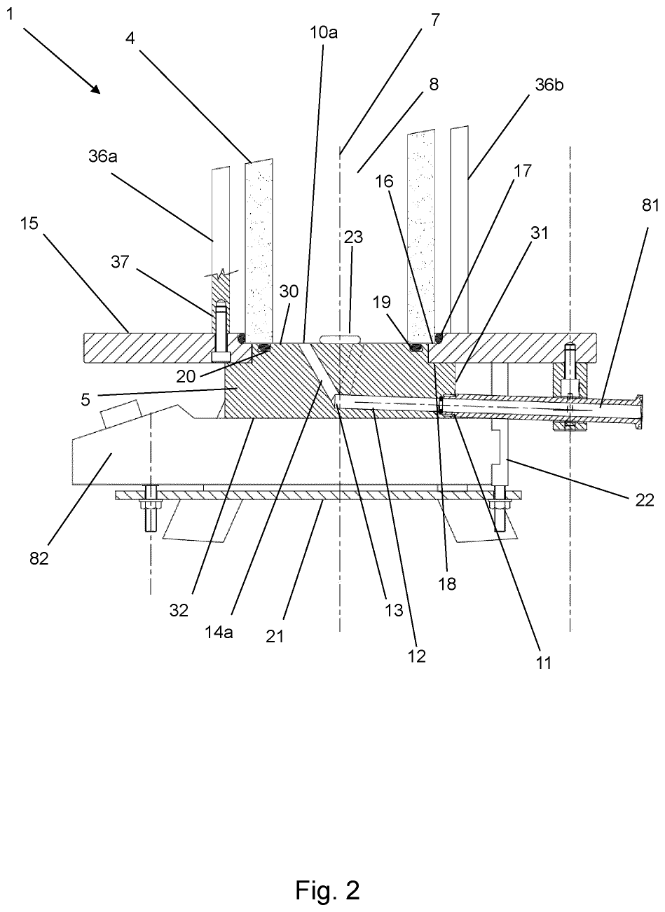

FIG. 1 shows an expanded bed chromatography apparatus 1 according to the present invention. The apparatus comprises an elongate tube 4 defining an operating volume 8. One end of the tube 4 (i.e. the top end) is sealed with a cap 2 having an exit port 3. The other end of the tube 4 is sealed by a base 5 which has a process fluid inlet which includes an inlet conduit 12 (see FIG. 2). The base 5 is made from a transparent material. The apparatus is supported on wheeled support legs e.g. 6a, 6b. The tube 4 has a central elongate axis 7. The tube 4 has an inner diameter of about 100 mm.

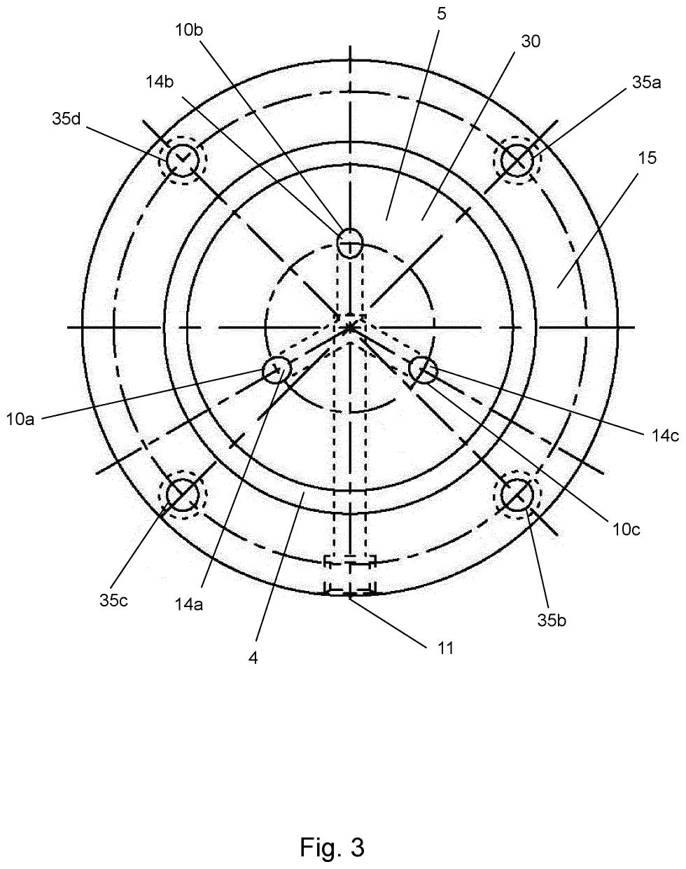

In use, the operating volume 8 is filled with a bed of adsorbent media particles in an expanded (fluidised) state which include the stationary phase. The process fluid (also known as the mobile phase) containing the target components enters the apparatus 1 through a process fluid inlet comprising an inlet aperture 11, an inlet conduit 12 and a plurality of outlet apertures 10a, 10b, 10c (see FIG. 2 and FIG. 3) and flows up the tube 4 towards the cap 2 and out of the exit port 3. Target components are adsorbed onto the adsorbent media and subsequently eluted from it. Alternatively, impurities are adsorbed on the particulate media and the target solution passes through the expanded bed for collection.

FIG. 2 shows an enlarged view of the bottom of the apparatus 1 shown in FIG. 1. The base 5 comprises a plurality of outlet apertures 10a, 10b, 10c in a top surface 30 (i.e. inner surface) which faces the operating volume 8 of the tube 4 such that the plurality of outlet apertures 10a, 10b, 10c are in fluid communication with the operating volume 8 of the tube 4. The plurality of outlet apertures 10a, 10b, 10c in the base 5 can be best seen in FIG. 3. In this embodiment, there are three outlet apertures. The three outlet apertures 10a, 10b, 10c are spaced circumferentially about the central axis 7 of the tube 4. As seen in FIG. 3, the three outlet apertures 10a, 10b, 10c are located on (i.e. circumscribe) a circle centred about the central axis 7 of the tube 4. The three outlet apertures 10a, 10b, 10c are evenly spaced around the central axis 7 of the tube 4. As seen in FIG. 3, each of the three outlet apertures 10a, 10b, 10c are respectively located on a radius of the tube 4 and each of the three radii are circumferentially spaced by about 120 degrees.

As seen in FIGS. 2 and 3, the three outlet apertures 10a, 10b, 10c are located proximate the tube 4. Best seen in FIG. 3, each of the three of outlet apertures 10a, 10b, 10c are radially spaced from the central axis 7 by a first radial spacing which is greater than the radial spacing from the wall of the tube 4.

The inlet aperture 11 is at the side 31 of the base 5, transverse to the top/inner surface 30 of the base 5. The base 5 comprises an inlet conduit 12 which extends from, and is in fluid communication with, the inlet aperture 11. The inlet conduit 12 divides at a conduit junction 13 to form three outlet portions 14a, 14b, 14c of the inlet conduit 12. Each of the three outlet portions 14a, 14b, 14c correspond to and are in fluid communication with a respective one of the three outlet apertures 10a, 10b, 10c. The process fluid i.e. the mobile phase, flows from the inlet aperture 11, through the inlet conduit 12 to the conduit junction 13. From the conduit junction 13 the flow of the mobile phase is divided between the three outlet portions 14a, 14b, 14c and into the tube 4 via the three outlet apertures 10a, 10b, 10c. The outlet portions 14a, 14b, 14c extend at an upward angle from the conduit junction 13.

The inlet aperture 11 is configured to receive a pipe 81 having a standardised connector which ensures the inlet aperture may be in fluid communication with the source of the process fluid (not shown). The inlet conduit 12 has a circular cross-section. Each of the outlet portions 14a, 14b, 14c has a circular cross-section. In the embodiment shown in FIG. 2, each of the outlet portions 14a, 14b, 14c each have a diameter of about 8 mm. The rest of the inlet conduit 12 has a diameter of about 10 mm.

As shown in FIG. 3, each of the outlet apertures 10a, 10b, 10c is an oval shape in the plane of the top surface 30 of the base 5 facing the tube (i.e. the plane of FIG. 3). This is a result of the outlet portions 14a, 14b, 14c of the inlet conduit 12 having a circular cross-section and extending at an angle to the plane of the top/inner surface 30 of the base 5 facing the tube from the outlet apertures 10a, 10b, 10c to the conduit junction 13.

To facilitate division of the mobile phase at the conduit junction 13, the apparatus 1 is provided with a flow distributor (not shown). The flow distributor moves within the conduit junction so that it can cover or partially cover one of the outlet portions 14a, 14b, 14c when there is preferential flow through that outlet portion. The flow distributor may also promote turbulent flow within the conduit junction 13 to promote even division of the flow between the outlet portions 14a, 14b, 14c. The flow distributor is magnetic so that it moves under influence of a magnetic stirring device (see below).

The base 5 is made of acrylic plastic (i.e. polymethyl methacrylate). The base 5 is cylindrical having a base diameter which extends from left to right in FIG. 2.

The base 5 is connected to the tube 4 at the top surface 30 of the base i.e. the tube 4 abuts the base 5 at the top surface 30. A connecting member which is a flange 15 is connected to both the base 5 and the tube 4 proximate the connection between the base 5 and the tube 4 such that the flange 15 surrounds the abutment between the tube 4 and the base 5. The flange 15 is in the shape of a circular disc. In other embodiments, the flange 15 may have a different shape. The flange 15 has a diameter greater than the base diameter of the base 5 such that the flange 15 overhangs the base 5. The flange 15 has a centre which is aligned along the central axis 7 of the tube 4. The base 5 has a centre which is aligned along the central axis 7 of the tube 4. The flange 15 has a central hole (i.e. aperture) so that the three outlet apertures 10a, 10b, 10c are in fluid communication with the operating volume 8 of the tube 4.

The flange 15 comprises a recess 16 which receives the tube 4. The shape of the recess 16 matches the shape of the tube 4. For example, in this embodiment the recess 16 is a circular recess. The tube 4 is secured in the recess 16 by an o-ring 17 which sits around the outer diameter of the tube 4.

The flange 15 rests on a base recess 18 in the top surface 30 of the base 5 such that the recess 16 in the flange 15 aligns with the top surface 30 of the base. A second sealing o-ring 20 is provided in a sealing o-ring recess 19 in the top surface 30 of the base 5. The second sealing o-ring 20 seals the interface between the tube 4 and the base 5. The second sealing o-ring 20 ensures that liquid does not escape between the tube 4 and the base 5.

The base 5, the flange 15 and the tube 4 are separable. In other words, they are removably connected to each other. As shown in FIG. 3, the flange 15 has holes 35a, 35b, 35c, 35d so that wheeled support legs e.g. 6a, 6b can be attached to the apparatus. As shown in FIGS. 1 and 2, rods (e.g. 36a, 36b in FIG. 2) are attached to the flange. The rods (e.g. 36a, 36b) are attached to the flange 15 with screws (see screw 37 and rod 36a in FIG. 2). In this embodiment there are three rods, although in other embodiments there may be two, four, five or more rods. The rods extend from the flange 15, parallel with the tube 4, to the top of the tube 4 where they are attached to the cap 2 (see also FIG. 1).

The apparatus 1 comprises a shelf 21, configured to support a magnetic stirring device 82. The magnetic stirring device 82 is an off-the-shelf magnetic stirring device. The shelf 21 is attached to the apparatus 1 via members 22 connected to and extending down from the flange 15. The shelf 21 is substantially parallel with the flange 15 and the top/inner surface 30 and bottom/outer surface 32 of the base 5. Not shown in FIG. 2, the shelf 21 comprises an alignment feature which is configured to align the magnetic stirring device 82 with the base 5 and the tube 4. In the embodiment shown, the magnetic stirring device 82 is aligned such that a rotation axis of the rotating magnetic field in the magnetic stirring device 82 is collinear with the central axis 7 of the tube 4. Accordingly, the rotatable magnetic stirring component 23 (which is an elongate bar in the embodiment shown) rotates about the central axis 7 of the tube 4 when the rotating magnetic field in the magnetic stirring device 82 rotates the magnetic stirring component 23. In other embodiments, the rotatable magnetic stirring component 23 may have an alternative form. For example, a flea which is a disc with radially extending spokes or a flea having four radially extending, perpendicular arms (i.e. a cruciform shape). As is known in the art, the rotatable magnetic stirring component may be coated with polytetrafluoroethylene (PTFE).

The depth of the base 5 i.e. between the top/inner surface 30 and the bottom/outer surface 32 is such that the rotatable magnetic stirring component 23 remains coupled with the magnetic stirring device 82. For example, in the embodiment shown in FIG. 2, the depth of the base is about 60 mm.

The rotatable magnetic stirring component 23 comprises a neodymium magnet. In the embodiment shown, the rotatable magnetic stirring component 23 does not sweep over the outlet apertures 10a, 10b, 10c. As seen in FIG. 2, the rotatable magnetic stirring component 23 has a maximum dimension which is less than twice the first radial spacing of the outlet apertures 10a, 10b, 10c from the central axis 7 of the tube 4 and is aligned with the central axis 7 of the tube 4. Thus, the rotatable magnetic stirring component 23 does not sweep over the outlet apertures 10a, 10b, 10c. In other embodiments, the rotatable magnetic stirring component 23 may sweep over or partially sweep over the outlet apertures 10a, 10b, 10c.

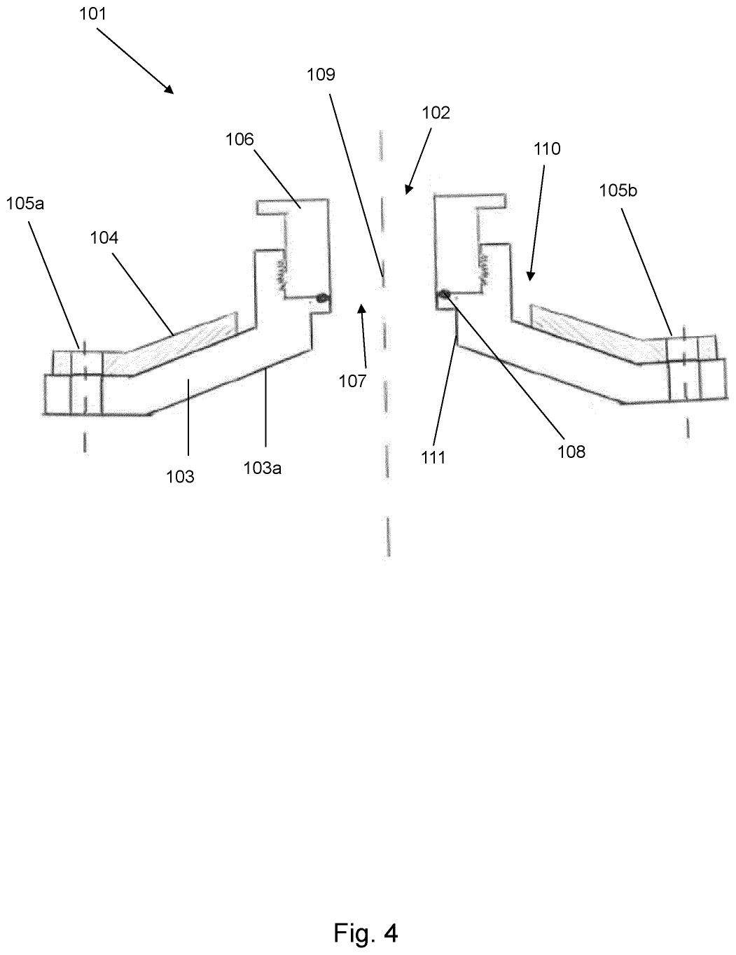

FIG. 4 shows a cross-section of a cap 101 for an expanded bed chromatography apparatus. The cap 101 seals/closes the top end of the tube of an expanded bed chromatography apparatus (e.g. cap 101 may be used in place of cap 2 in FIG. 1). The cap 101 comprises an exit port 102 and a disposable liner 103 which in use closes the top of an expanded bed chromatography apparatus tube. The disposable liner 103 has an operating surface 103a which is configured to face the operating volume of an expanded bed chromatography apparatus tube when in use. On the side of the liner 103 opposite the operating surface 103a is a support structure 104 which is removably connectable to the liner 103 such that the support structure 104 reinforces the liner 103.

The support structure 104 overlays the liner 103. The cap has a central axis 109 and the operating surface 103a is inclined at an angle to the central axis 109 such that it converges to a liner aperture 107. The liner aperture 107 is aligned with the central axis 109 of the cap. In use, the central axis 109 of the cap aligns with the central axis of the expanded bed chromatography apparatus tube (e.g. 7 in FIG. 1).

The liner 103 and the support structure 104 have a conical shape. The support structure 104 has a support structure aperture 110 which is aligned with the central axis 109 of the cap 101 and the liner aperture 107. A portion of the liner 103 extends through the support structure aperture 110 and lines the support structure aperture 110 to form the exit port 102. In other words, the liner aperture 107 is contained within the support structure aperture 110.

The liner 103 is polypropylene and the support structure 104 is stainless steel. In other embodiments, the liner may be another plastic. Fixing apertures 105a, 105b are provided through the liner 103 and the support structure 104 such that the liner 103 and the support structure 104 can be bolted together and to the top of the tube of the expanded bed chromatography apparatus e.g. to a flange at the top of the tube.

An exit conduit 106 is connected via an internal thread of the liner aperture 107 to the liner 103 such that the liner aperture 107 and the exit conduit 106 form the exit port 102. An o-ring seal 108 is provided between the exit conduit 106 and the liner 103. In other embodiments, a flat or tri-clamp seal/gasket may be provided.

A vortex inhibiting structure (not shown) may be connected to the cap 101 at a threaded connection region 111 (thread not shown in FIG. 4). In use, the vortex inhibiting structure extends from the cap into the operating volume of the chromatography apparatus.

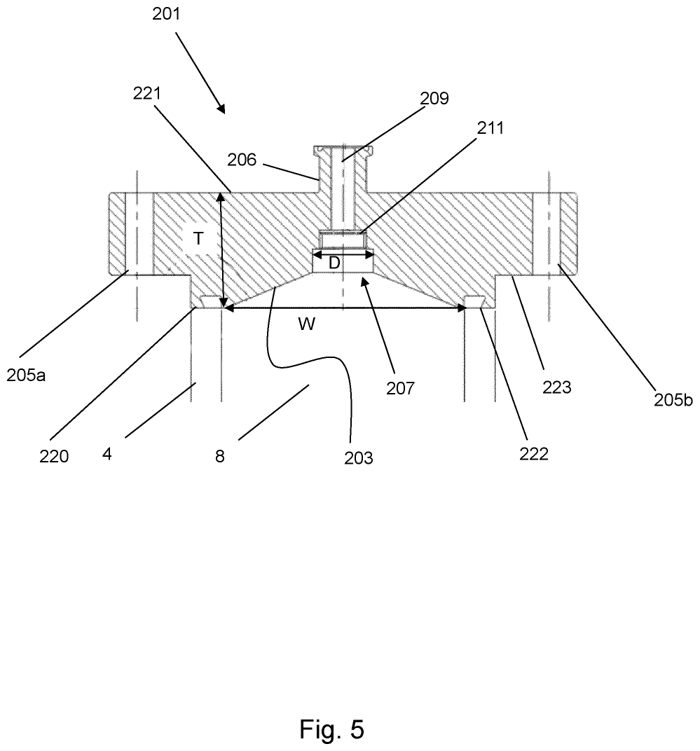

FIG. 5 shows a cross-sectional view of an alternative cap 201 for an expanded bed chromatography apparatus. The cap 201 seals/closes the top end of the tube of an expanded bed chromatography apparatus (e.g. cap 201 may be used in place of cap 2 in FIG. 1).

The cap has a central axis 209 which in use may align with the central axis of the expanded bed chromatography apparatus tube (e.g. central axis 7 in FIG. 1). The cap 201 has an exit port 207 aligned with the central axis 209 and an operating surface 203 which in use faces the operating volume of the expanded bed chromatography apparatus (e.g. operating volume 8 in FIG. 1).

The operating surface 203 spans an operating surface width W which is perpendicular to the central axis 209 of the cap and which is measured from one peripheral point of the operating surface 203 to an opposite peripheral point of the operating surface 203. The width W is equivalent to the inner diameter of the expanded bed chromatography apparatus tube 4. The cap 201 has a thickness T which is the maximum spacing between the operating surface 203 and a top surface 221 of the cap 201. The top surface 221 is substantially perpendicular to the central axis of the cap 209.

The thickness T of the cap 201 is about one half of the operating surface width W.

The operating surface 203 is a concave cone which directs fluid from the operating volume to the exit port 207. The periphery of the concave cone is extends to a connecting surface 220 which connects to the upper perimeter of the apparatus tube 4.

The exit port 207 has an exit port diameter D which is the largest diameter of the exit port 207. The thickness T is about 1.9 times the exit port diameter D.

The exit port 207 has an exit port conduit 206 which extends upwardly away from the top surface 221. The exit port 207 is in fluid communication with the operating volume 8 of the tube 4.

A vortex inhibiting structure (not shown) may be connected to the cap 201 at a threaded connection region 211. In use, the vortex inhibiting structure extends from the cap into the operating volume of the chromatography apparatus.

The cap 201 includes a seal 222 between the cap 201 and the tube 4 such that the cap 201 is engageable with the tube 4. The cap 201 includes fixing/fastener apertures 205a, 205b which extend from the top surface 221 through the cap 201 to an overhanging surface 223. The fixing/fastener apertures 205a, 205b are at the periphery of the of the cap 201. The fixing/fastener apertures 205a, 205b are configured to receive fixing/fastener members e.g. rods, bolts (not shown) such that the cap 201 may be fixed/fastened to the expanded bed chromatography apparatus (e.g. apparatus 1). The cap 201 is removable and replaceable from the apparatus 1 such that it is single use. The cap 201 is made from transparent acrylic plastic.

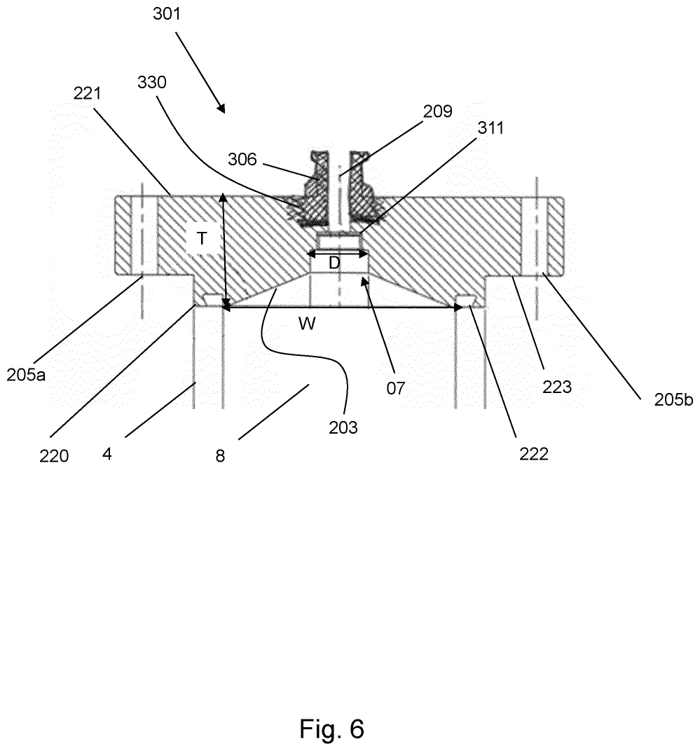

FIG. 6 shows a cross-sectional view of an alternative cap 301 for an expanded bed chromatography apparatus. The cap 301 has the same features as the cap 201 (corresponding features indicated with the same last two digits as FIG. 5). The cap 301 has an operating surface width W, a thickness T and an exit port diameter as described in relation to FIG. 5.

Unlike the exit port conduit 206, a portion of the exit port conduit 306 is removable from the cap 301 and is replaceable. The removable portion of the exit port conduit 306 is threadedly connected to the cap 301 at threaded connection 330. The removable portion of the exit conduit 306 is made from polypropylene and the rest of the cap 301 is made from transparent acrylic plastic.

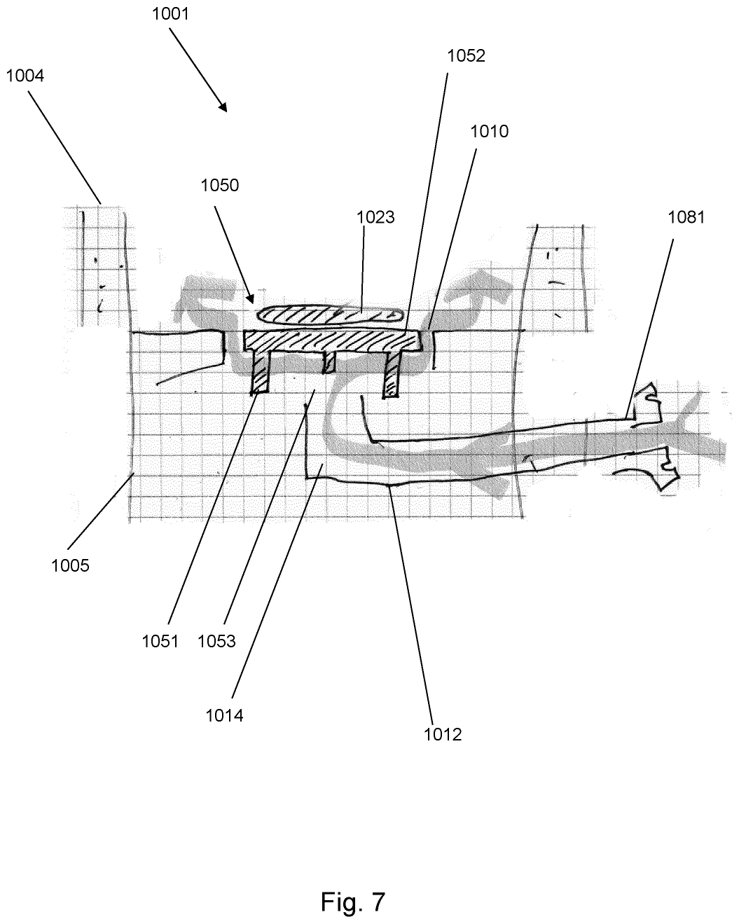

FIG. 7 shows a cross-section side view of a variation of the expanded bed chromatography apparatus base shown in FIGS. 1 to 3. The same or similar features in FIG. 7 are shown with reference numerals having the same last two digits used in FIGS. 1 to 3.

The expanded bed chromatography apparatus 1001 in FIG. 7 has many of the same features as the expanded bed chromatography apparatus 1 shown in FIGS. 1 to 3. For example, expanded bed chromatography apparatus 1001 has a tube 1004 and a base 1005 connected to the tube 1004. There is an inlet conduit 1012 in the base and a rotatable magnetic stirring component 1023. The base has a single annular aperture 1010. Other features of the expanded bed chromatography apparatus 1001 which are not shown are the same as those shown in FIGS. 1 to 3.

The expanded bed chromatography apparatus 1001 differs in that there is a single outlet portion 1014 which is in fluid communication with the inlet conduit 1012. The single outlet portion 1014 is aligned with the central axis of the base 1005. The base 1005 has a recess 1053 over the single outlet portion 1014. The recess 1053 contains a circumferential distributor 1050 on which the stirring component 1012 rests. The circumferential distributor 1050 includes an upper portion 1052 which is a circular disc and three support members 1051 extending from the upper portion 1052 and which support the circumferential distributor 1050 in the recess 1053. The circumferential distributor 1050 fits in the recess 1053 such that there is a gap between the circumferential distributor 1050 and the edge of the recess 1053.

As shown by the flow path arrows in FIG. 7, process fluid flows through the inlet conduit 1012, the outlet portion 1014 and then between the edge of the recess 1053 and the circumferential distributor 1050 through the single annular outlet aperture 1010. Accordingly, the aperture formed in the base 1005 is an annular aperture spaced radially from the central axis of the base 1005.

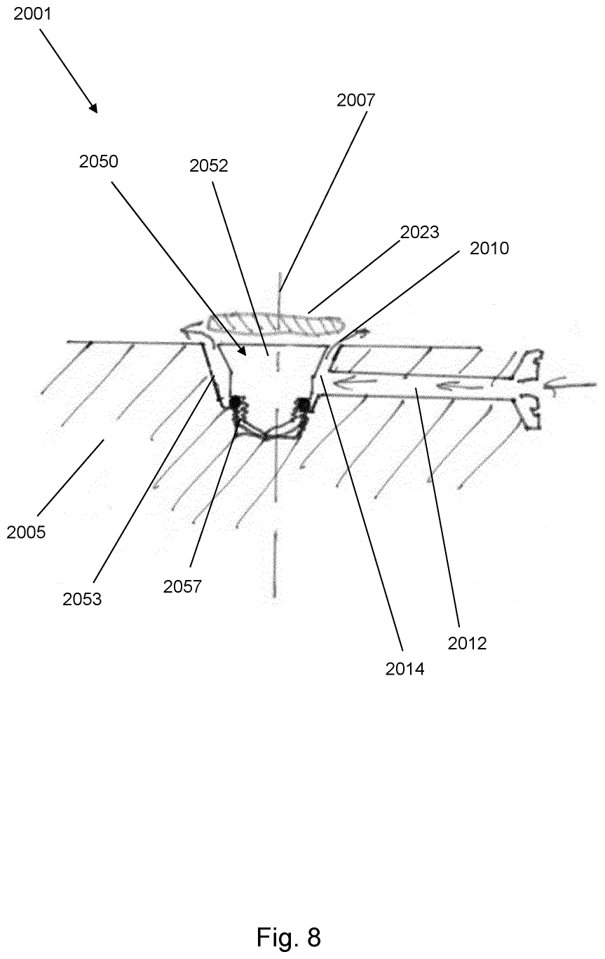

FIG. 8 shows a cross-section side view of a variation of the expanded bed chromatography apparatus base shown in FIGS. 1 to 3 and 7. The same or similar features in FIG. 8 are shown with reference numerals having the same last two digits used in FIGS. 1 to 3 and 7.

The expanded bed chromatography apparatus 2001 in FIG. 8 has many of the same features as the expanded bed chromatography apparatus 1 shown in FIGS. 1 to 3 and 7. For example, expanded bed chromatography apparatus 2001 has a base 2005 which connects to a tube (e.g. tube 4 or tube 1004). There is an inlet conduit 2002 in the base and a rotatable magnetic stirring component 2023. The base has a single annular aperture 2010. Other features of the expanded bed chromatography apparatus 2001 which are not shown are the same as those shown in FIGS. 1 to 3 and 7.

The expanded bed chromatography apparatus 2001 differs in that there is a single outlet portion 2014 which is in fluid communication with the inlet conduit 2012. The single outlet portion 2014 is aligned with the central axis of the base 2005. The base 2005 has a recess 2053 over the single outlet portion 2014

The recess 2053 contains a circumferential distributor 2050 which has a diameter smaller than the diameter of the recess 2053. The circumferential distributor 2050 has an upper portion 2052 which is flared such that the diameter of the circumferential distributor 2050 is greater proximate the single annular aperture 2010 than proximate the inlet conduit 2012. The annular aperture 2010 is formed between the edge of the recess 2053 and the circumferential distributor 2050 (specifically the flared upper portion 2052).

The circumferential distributor 2050 is removably connected to the base via a threaded connection 2057.

As shown by the flow path arrows in FIG. 8, process fluid flows through the inlet conduit 2012, the outlet portion 2014 and then between the edge of the recess 2053 and the circumferential distributor 2050 through the single annular outlet aperture 2010. Accordingly, the aperture formed in the base 2005 is an annular aperture spaced radially from the central axis 2007 of the base 2005.

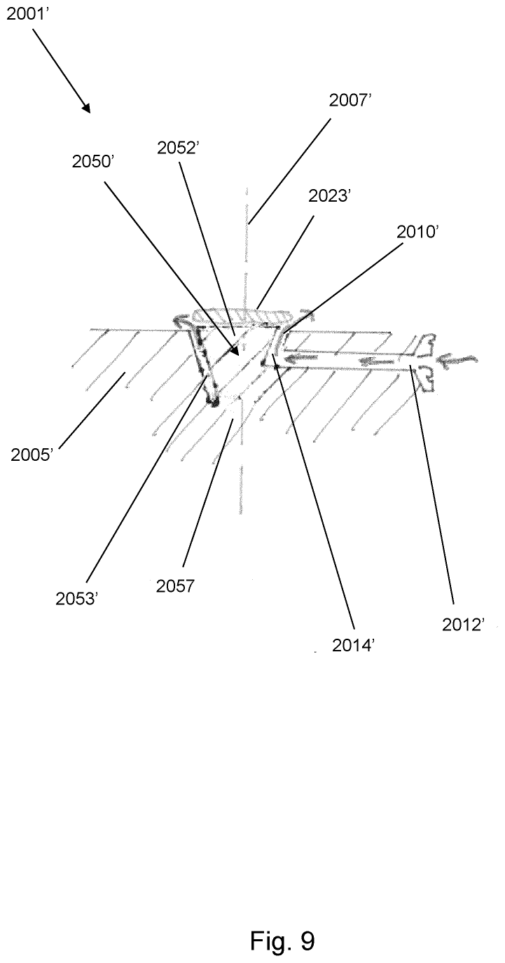

FIG. 9 shows a further embodiment similar to FIG. 8 except that the circumferential distributor 2050′ is integrally formed with the base 2005′.

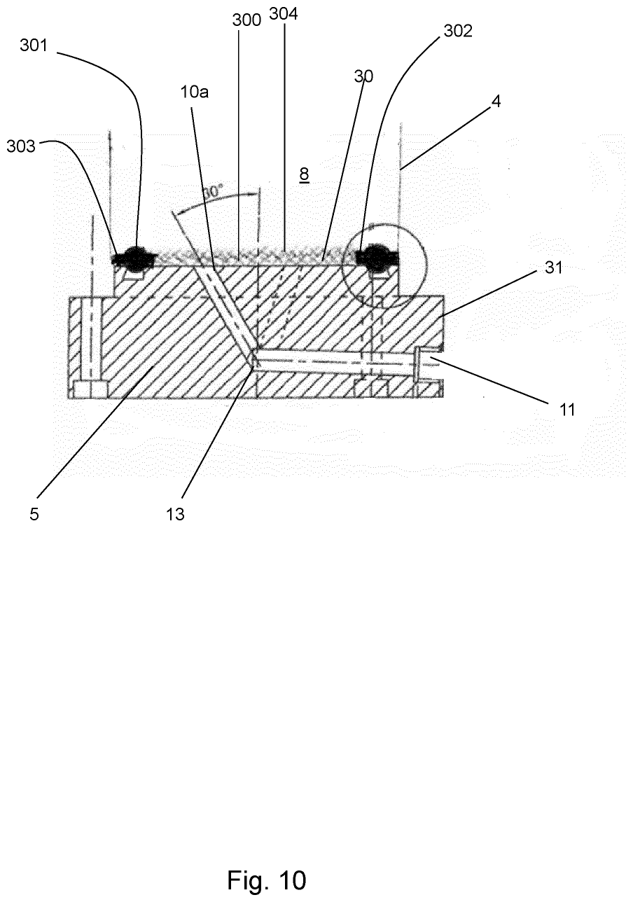

FIG. 10 shows a variation on the base shown in FIG. 2 and like reference numerals are used. A base mesh layer 300 is provided adjacent the base 5. The base mesh layer 300 overlies the top/inner surface 30 of the base 5 such that it is interposed between the base 5 and the operating volume 8 of the tube 4. The base mesh layer 300 is planar and lies substantially parallel to the top/inner surface 30 of the base 5.

The base mesh layer is dimensioned to cover the plurality of outlet apertures 10a, 10b, 10c and it covers substantially all of the top/inner surface 30 of the base 5.

The base mesh layer 300 is formed of stainless steel or hydrophobic polypropylene. It has a mesh size of around 40 microns.

The base mesh layer 300 is welded to a base sealing ring 301 at its outer perimeter for sealing against the base 5 and tube 4. The base sealing ring 301 is formed of biocompatible ethylene propylene diene monomer (EDPM).

The base sealing ring 301 is an o-ring having a substantially circular transverse cross section (parallel to the axis of the tube).

The base sealing ring 301 has a radially inner flange 302 which is substantially planar (i.e. is a disc shaped radially inner flange) and the base mesh layer 300 is welded to or heat-sealed within the radially inner flange 302. There is also a radially outer flange 303 which is substantially planar (i.e. is a disc shaped radially outer flange) and the radially outer flange 303 seals against the tube 4.

The base mesh layer 300 is removably attached to the base sealing ring 301 so that the base mesh layer can be replaced.

There may also be provided a base mesh support layer 304.

The base mesh support layer 304 overlies the top/inner surface 30 of the base 5 such that it is interposed between the base 5 and the base mesh layer 300. The base mesh support layer 304 is planar and lies substantially parallel to the top/inner surface 30 of the base 5.

The base mesh support layer 304 is dimensioned to cover the plurality of outlet apertures 10a, 10b, 10c and it covers substantially all of the top/inner surface 30 of the base 5. It has the same dimensions as the base mesh layer 300.

The base mesh support layer 304 is formed of hydrophobic polypropylene or polyethylene. The base mesh support layer 304 has a greater mesh size than the base mesh layer 300. The base mesh support layer has a mesh size of around 100 microns.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. An expanded bed chromatography apparatus comprising:
a tube defining an operating volume and having a central axis; and
a base connected to the tube, the base comprising:
a process fluid inlet having a plurality of outlet apertures or an annular aperture in fluid communication with the operating volume of the tube,
wherein each of the plurality of outlet apertures or the annular aperture is spaced radially from the central axis of the tube.

2. The expanded bed chromatography apparatus according to claim 1, wherein the plurality of outlet apertures comprises three or more outlet apertures in fluid communication with the operating volume of the tube and wherein each of the three or more outlet apertures is spaced radially from the central axis of the tube.

3. The expanded bed chromatography apparatus according to claim 1, wherein the plurality of outlet apertures are substantially evenly circumferentially spaced about the central axis of the tube.

4. The expanded bed chromatography apparatus according to claim 1, wherein each of the plurality of outlet apertures is located proximate an interior surface of the tube.

5. The expanded bed chromatography apparatus according to claim 1, wherein the process fluid inlet comprises:
an inlet conduit in fluid communication with the plurality of outlet apertures,
wherein the inlet conduit divides at a conduit junction to form a plurality of outlet portions, each of the plurality of outlet portions corresponding to and in fluid communication with a respective one of the plurality of outlet apertures,
and wherein the conduit junction comprises a flow distributor.

6. The expanded bed chromatography apparatus according to claim 5, wherein the flow distributor is magnetic.

7. The expanded bed chromatography apparatus according to claim 1, wherein the base or a portion of the base is transparent.

8. The expanded bed chromatography apparatus according to claim 1, wherein the base is removably connected to the tube.

9. The expanded bed chromatography apparatus according to claim 1, comprising an alignment feature configured to align a magnetic stirring device with the apparatus.

10. The expanded bed chromatography apparatus according to claim 1, wherein the base comprises a top surface facing the operating volume of the tube and a side surface transverse to the top surface, and wherein the process fluid inlet comprises an inlet aperture in the side surface.

11. The expanded bed chromatography apparatus according to claim 1, wherein the base and the tube are removable from the apparatus and replaceable such that the base and the tube are single-use components.

12. An expanded bed chromatography system comprising:
an expanded bed chromatography apparatus according to a claim 1;
a magnetic stirring device located underneath the base of the expanded bed chromatography apparatus; and
a rotatable magnetic stirring component received in the tube of the expanded bed chromatography apparatus and configured to magnetically couple with the magnetic stirring device such that the rotatable magnetic stirring component is rotatable under influence of the magnetic stirring device.

13. An expanded bed chromatography apparatus base having a base central axis, the base comprising:
a top surface perpendicular to the base central axis,
wherein the base comprises a process fluid inlet having a plurality of outlet apertures or an annular aperture in the top surface of the base for fluid communication with an operating volume of a tube of an expanded bed chromatography apparatus,
wherein each of the plurality of outlet apertures or the annular aperture is spaced radially from the base central axis.

14. The expanded bed chromatography apparatus base according to claim 13, wherein the plurality of outlet apertures comprises three or more outlet apertures for fluid communication with the operating volume of the tube and wherein each of the three or more outlet apertures is spaced radially from the base central axis.

15. The expanded bed chromatography apparatus base according to claim 13, wherein the plurality of outlet apertures are substantially evenly circumferentially spaced about the base central axis.

16. The expanded bed chromatography apparatus base according to claim 13, wherein the process fluid inlet comprises:
an inlet conduit in fluid communication with the plurality of outlet apertures,
wherein the inlet conduit divides at a conduit junction to form a plurality of outlet portions, each of the plurality of outlet portions corresponding to and in fluid communication with a respective one of the plurality of outlet apertures,
and wherein the conduit junction comprises a flow distributor.

17. The expanded bed chromatography apparatus base according to claim 16, wherein the flow distributor is magnetic.

18. The expanded bed chromatography apparatus base according to claim 13, wherein the base or a portion of the base is transparent.

19. The expanded bed chromatography apparatus base according to claim 13, wherein the base comprises a side surface transverse to the top surface, and wherein the process fluid inlet comprises an inlet aperture in the side surface.

20. An expanded bed chromatography system comprising:
an expanded bed chromatography apparatus comprising:
a tube defining an operating volume and having a central axis; and
a base connected to the tube, the base comprising:
a top surface facing the operating volume;
a transverse side surface; and
a process fluid inlet having an inlet aperture in the side surface and an outlet aperture in the top surface in fluid communication with the operating volume of the tube,
wherein the outlet aperture is spaced radially from the central axis of the tube;
the expanded bed chromatography system further comprising:
a magnetic stirring device located underneath the base of the expanded bed chromatography apparatus; and
a rotatable magnetic stirring component received in the tube of the expanded bed chromatography apparatus and configured to magnetically couple with the magnetic stirring device such that the rotatable magnetic stirring component is rotatable under influence of the magnetic stirring device.

21. The expanded bed chromatography system according to claim 20, wherein the outlet aperture is spaced from the central axis of the tube by a first radial spacing and
wherein the rotatable magnetic component has a maximum dimension less than twice the first radial spacing and is aligned with the central axis of the tube.

22. The expanded bed chromatography system according to claim 21, wherein the apparatus comprises an alignment feature configured to align the magnetic stirring device with the apparatus.

23. An expanded bed chromatography apparatus, for use with the expanded bed chromatography system of claim 20, comprising:
a tube defining an operating volume and having a central axis; and
a base connected to the tube, the base comprising:
a top surface facing the operating volume;
a transverse side surface; and
a process fluid inlet having an inlet aperture in the side surface and an outlet aperture in the top surface in fluid communication with the operating volume of the tube,
wherein the outlet aperture is spaced radially from the central axis of the tube.

24. An expanded bed chromatography apparatus base, for use with the expanded bed chromatography system of claim 20, comprising:
a top surface facing the operating volume;
a transverse side surface; and
a process fluid inlet having an inlet aperture in the side surface and an outlet aperture in the top surface in fluid communication with the operating volume of the tube, wherein, in use, the outlet aperture is configured to be spaced radially from the central axis of the tube.

25. An expanded bed chromatography apparatus cap comprising:
an exit port;
a liner for closing an expanded bed chromatography apparatus tube, the liner having an operating surface which in use is configured to face an operating volume of the expanded bed chromatography apparatus tube; and
a support structure on a side of the liner opposite the operating surface, wherein the support structure is removably connected to the liner such that the support structure reinforces the liner.

26. An expanded bed chromatography apparatus cap for closing an expanded bed chromatography apparatus tube, the expanded bed chromatography apparatus cap comprising: an exit port having an exit port diameter, and an operating surface which in use is configured to face the operating volume of an expanded bed chromatography apparatus, the operating surface spanning an operating surface width and the cap having a maximum thickness between the operating surface and an opposing top surface, wherein the maximum thickness is between 0.2 and 2 times the operating surface width and/or the maximum thickness of the cap is 0.8 to 5 times the exit port diameter.
